(19) United States
(12) Patent Application Publication
(10) Pub. No.: US 2014/0083507 A1
(43) Pub. Date: Mar. 27, 2014

(54) DYE-SENSITIZED SOLAR CELL

(71) Applicant: ELECTRONICS AND TELECOMMUNICATIONS RESEARCH INSTITUTE, Daejeon (KR)

(72) Inventor: Ho-Gyeong YUN, Seoul (KR)

(73) Assignee: Electronics and Telecommunications Research Institute, Daejeon (KR)

(21) Appl. No.: 13/767,942

(22) Filed: Feb. 15, 2013

(30) Foreign Application Priority Data
Sep. 24, 2012 (KR) 10-2012-0105884

(51) Int. Cl. H01G 9/20

(52) U.S. Cl. CPC H01G 9/2059
USPC 136/263

(57) ABSTRACT

Provided is a dye-sensitized solar cell. The dye-sensitized solar cell includes a first metallic substrate disposed on a first transparent film, a first electrode disposed on one surface of the first metallic substrate, a second metallic substrate facing the first metallic substrate, a second electrode disposed on one surface of the second metallic substrate to face the first electrode, and an electrolyte disposed between the first electrode and the second electrode. The first metallic substrate includes a plurality of holes exposing a portion of the first transparent film.

### CROSS-REFERENCE TO RELATED APPLICATIONS

This U.S. non-provisional patent application claims priority under 35 U.S.C. §119 of Korean Patent Application No. 10-2012-0105884, filed on Sep. 24, 2012, the entire contents of which are hereby incorporated by reference.

### BACKGROUND OF THE INVENTION

The present invention disclosed herein relates to a solar cell, and more particularly, to a dye-sensitized solar cell.

Since dye-sensitized solar cells are manufactured with low manufacturing costs and simple processes, the dye-sensitized solar cells are being considered as promising fields for solar cell production. Such a dye-sensitized solar cell may include dye molecules which receive visible light to generate pairs of electrons-holes, an oxide semiconductor capable of receiving excited electrons, and an electrolyte reacting with the electrons.

Dye-sensitized solar cells are expanded in applicability by giving flexibility thereto using a polymer film to which a conductive layer is applied, such as indium tin oxide (ITO) substrate or fluorine tin oxide (FTO) substrate. However, since the ITO or FTO substrate is expensive, the manufacturing costs of the dye-sensitized solar cell may be significantly increased.

### SUMMARY OF THE INVENTION

The present invention provides a dye-sensitized solar cell having saved manufacturing costs.

The object of the present invention is not limited to the aforesaid, but other objects not described herein will be clearly understood by those skilled in the art from descriptions below.

Embodiments of the present invention provide dye-sensitized solar cells including: a first metallic substrate disposed on a first transparent film; a first electrode disposed on one surface of the first metallic substrate; a second metallic substrate facing the first metallic substrate; a second electrode disposed on one surface of the second metallic substrate to face the first electrode; and an electrolyte disposed between the first electrode and the second electrode, wherein the first metallic substrate includes a plurality of holes exposing a portion of the first transparent film.

In some embodiments, the first electrode may include metal oxide particles and dye particles surrounded by the metal oxide particles.

In other embodiments, the dye-sensitized solar cells may further include a second transparent film disposed on the other surface of the second metallic substrate, wherein the second metallic substrate may include a plurality of holes exposing a portion of the second transparent film.

In still other embodiments, the second electrode may expose the holes of the second metallic substrate.

In even other embodiments, the second electrode may include metal oxide particles and dye particles surrounded by the metal oxide particles.

In yet other embodiments, the dye-sensitized solar cells may further include a second transparent film disposed on the other surface of the second metallic substrate, wherein the second metallic substrate may include a plurality of holes exposing a portion of the second transparent film.

In further embodiments, the first electrode may expose the holes of the first metallic substrate.

In still further embodiments, the first transparent film may be a film formed of a glass or polymer material.

In even further embodiments, the second metallic substrate may be a flat substrate.

In yet further embodiments, the plurality of the holes may be defined in central portions of the first metallic substrate.

In much further embodiments, each of the first metallic substrate and the second metallic substrate may be formed of a metal foil.

In still much further embodiments, each of the first metallic substrate and the second metallic substrate may be formed of titanium (Ti), nickel (Ni), silver (Ag), copper (Cu), tungsten (W), iron (Fe), an alloy including at least one of these metals, or stainless steel.

In even much further embodiments, the electrolyte may be filled into the plurality of holes of the first metallic substrate.

In yet much further embodiments, the dye-sensitized solar cells may further include sealing pillars disposed on both sides between the first electrode and the second electrode.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a cross-sectional view of a dye-sensitized solar cell according to an embodiment of the present invention;

FIG. 2A is an enlarged view of a portion A′ of FIG. 1;

FIG. 2B is a plan view of a metallic substrate of FIG. 1;

FIG. 3 is a cross-sectional view illustrating a modified example of the dye-sensitized solar cell of FIG. 1 according to an embodiment of the present invention;

FIG. 4 is a cross-sectional view of a dye-sensitized solar cell according to another embodiment of the present invention; and

FIG. 5 is a cross-sectional view illustrating a modified example of the dye-sensitized solar cell of FIG. 4 according to another embodiment of the present invention.

### DETAILED DESCRIPTION OF PREFERRED EMBODIMENTS

Advantages and features of the prevent invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining a specific exemplary embodiment while not limiting the present invention. The terms of a singular form may include plural forms unless referred to the contrary. The meaning of ‘comprises’ and/or ‘comprising’ specifies a component, a process, an operation and/or an element, but does not exclude other components, processes, operations, and/or elements.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable tolerances. Therefore, the embodiments of the present invention are not limited to the specific shape illustrated in the exemplary views, but may include other shapes that may be created according to manufacturing processes. For example, an etched region illustrated or described as a rectangle will, typically, have rounded or curved features. Areas exemplified in the drawings have general properties, and are used to illustrate a specific shape of a semiconductor package region. Thus, this should not be construed as limited to the scope of the present invention.

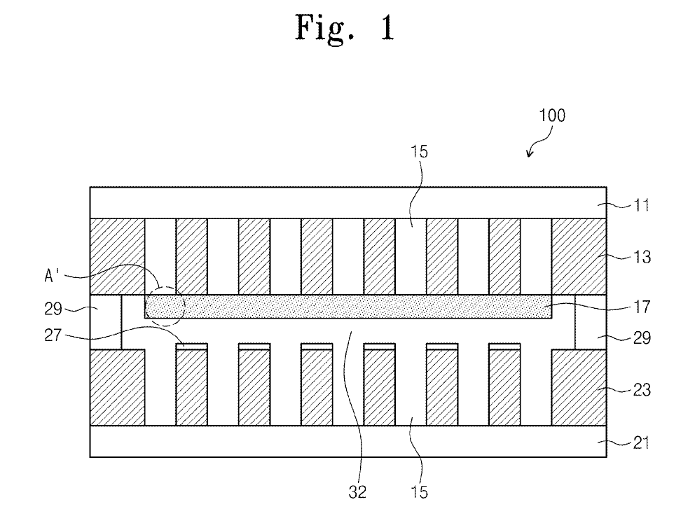

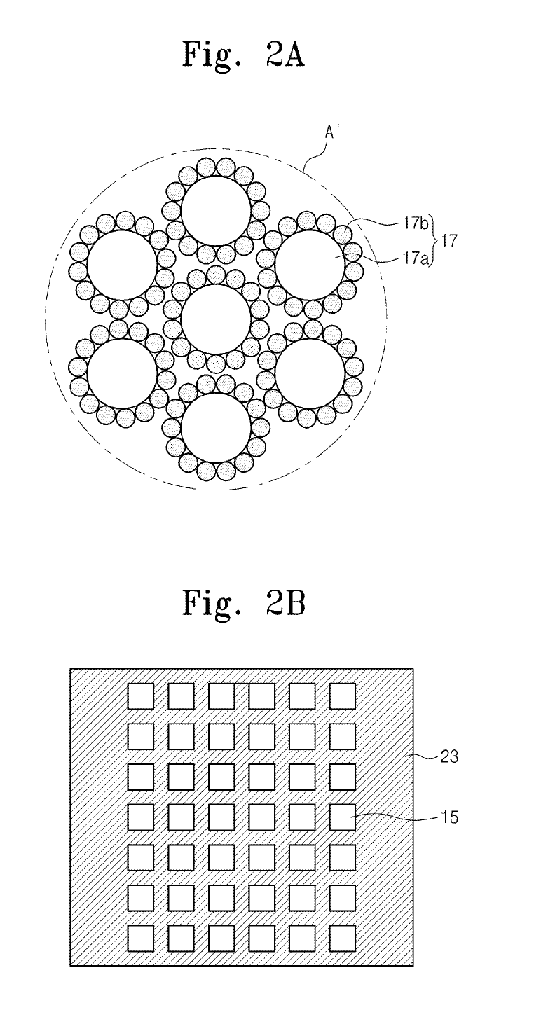

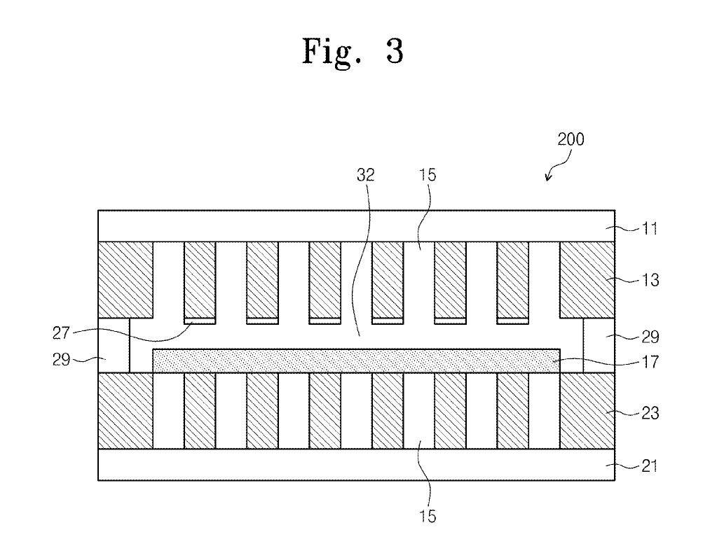

FIG. 1 is a cross-sectional view of a dye-sensitized solar cell according to an embodiment of the present invention. FIG. 2A is an enlarged view of a portion A′ of FIG. 1. FIG. 2B is a plan view of a metallic substrate of FIG. 1. FIG. 3 is a cross-sectional view illustrating a modified example of the dye-sensitized solar cell of FIG. 1 according to an embodiment of the present invention.

Referring to FIG. 1, a dye-sensitized solar cell 100 includes a first transparent film 11 and a second transparent film 21. A first metallic substrate 13 is disposed on one surface of the first transparent film 11, and a second metallic substrate 23 is disposed on one surface of the second transparent film 21. The first metallic substrate 13 and the second metallic substrate 23 are disposed facing each other.

The first transparent film 11 and the second transparent film 21 may be non-conductive transparent films, respectively. For example, the first transparent film 11 and the second transparent film 21 may be a film formed of a glass material or polymer material. The first transparent film 11 and the second transparent film 21 may be a hard or flexible film. External light may be incident into the first transparent film 11.

The first metallic substrate 13 and the second metallic substrate 23 may be formed of an opaque metal material. The first metallic substrate 13 and the second metallic substrate 23 may be formed of titanium (Ti), nickel (Ni), silver (Ag), copper (Cu), tungsten (W), iron (Fe), an alloy including at least one of these metals, or a combination thereof. Furthermore, the first metallic substrate 13 and the second metallic substrate 23 may be a stainless steel substrate. The first metallic substrate 13 and the second metallic substrate 23 may be a metal foil. The first metallic substrate 13 and second metallic substrate 23 may have a thickness of about several micrometers to or about several millimeters.

The first metallic substrate 13 and the second metallic substrate 23 may include a plurality of holes 15. Some portions of top surfaces of the first transparent film 11 and the second transparent film 21 may be exposed by the holes 15. The holes 15 may be formed in the first metallic substrate 13 and the second metallic substrate 23 through a photochemical machining (PCM) process. In, detail, a photoresist pattern may be formed on both surfaces of a metal film (not shown), and primary chemical etching process may be performed on both surfaces of the metal film exposed by the photoresist pattern. Then, secondary chemical etching may be performed on only one surface of the metal film.

Thereafter, when the photoresist pattern is removed, the first and second metallic substrates 13 and 23 having the holes 15 may be manufactured. In detail, as shown in FIG. 2B, the holes 15 may be formed in central portions of the first metallic substrate 13 and the second metallic substrate 23. The holes 15 may have a diameter of about several nanometers to about several millimeters. The holes 15 may have a circular shape, a rectangular shape, a polygonal shape, or various shapes. The holes 15 may be a path in which light is incident from the outside.

Referring again to FIG. 1, a sealing pillar 29 may be disposed between edges of the first metallic substrate 13 and the second metallic substrate 23. The sealing pillar 29 may attach the first metallic substrate 13 to the second metallic substrate 23. In detail, referring to FIGS. 1 and 2B, the sealing pillar 29 may be disposed on edge portions of the first metallic substrate 13 and the second metallic substrate 23 in which the holes 15 are not defined. Referring again to FIG. 1, the sealing pillar 29 may provide a space between the first metallic substrate 13 and the second metallic substrate 23. The sealing pillar 29 may be formed of a polymer material or an insulating material.

A semiconductor electrode 17 may be disposed on the first metallic substrate 13. Referring to FIG. 2A, the semiconductor electrode 17 may contain metal oxide particles 17a and dye particles 17b. The dye particles 17b may be surrounded by surfaces of the metal oxide particles 17a and be adsorbed with each other. The metal oxide particles 17a may have various shapes of nanometer size. For example, the metal oxide particles 17a may have a shape such as a nanotube, a nano rod, a nanohom, a nanosphere, a nanofiber, a nanoring, or a nanobelt. For example, the metal oxide particles 17a may be formed of TiO₂, SnO₂, ZnO, WO₃, Nb₂O₅, TiSrO₃, or a combination thereof.

A material in which electro-hole pairs are generated when the material receives light energy may be used as the dye particles 17b. The dye particles 17b may be, for example, formed of xanthene-based dyes such as ruthenium complex, rhodamine B, rose bengal, eosin, erythrosine, and the like, cyanine-based dyes such as quinocyanine, kryptocyanine, and the like, basic dye such as phenosafranine, capri blue, tyocyn, methylene blue, and the like, porphyrin-based complex such as chlorophyll, zinc porphyrin, magnesium-porphyrin, and the like, substrate azo dyes, complex compound such as phthalocyanine compound, ruthenium tris bipyridyl, and the like, anthraquinone-based dyes, or polycyclic quinine-based dyes. The above-described materials may be used alone or by mixing at least two materials thereof.

The semiconductor electrode 17 may be manufactured by performing an annealing process after a metal oxide paste containing the dye particles 17b is coated on the first metallic substrate 13. According to another embodiment, the semiconductor electrode 17 may be disposed on a portion between the holes 15.

Referring again to FIG. 1, a counter electrode 27 may be disposed on the second metallic substrate 23. The counter electrode 27 may be disposed to face the semiconductor electrode 17. The counter electrode 27 may expose a top surface of the second transparent film 21 exposed by the holes 15. The counter electrode 27 may be formed of a metal material having superior catalysis such as Pt, Ag, Au, or the like. The counter electrode 27 may be manufactured by performing a sputtering process.

Referring to FIG. 3 which illustrates a modified example of the dye-sensitized solar cell 100 of FIG. 1, a counter electrode 27 may be disposed on a first metallic substrate 13 in a dye-sensitized solar cell 200. A semiconductor electrode 17 may be disposed on a second metallic substrate 23. The counter electrode 27 may expose a top surface of a second transparent film 11 exposed by the holes 15.

Referring again to FIG. 1, an electrolyte 32 may be filled in a space between the first metallic substrate 13 and the second metallic substrate 23. The electrolyte 32 may include imidazole-based compound and iodine (e.g., an iodine-based redox electrolyte 32 (I/I₃)). The electrolyte 32 may be filled in the holes 15 defined in the first metallic substrate 13 and the second metallic substrate 23. As if the semiconductor electrode 17 covers the holes 15 defined in the first metallic substrate 13 in FIG. 1, the electrolyte 32 may be fluidly moved between the metal oxide particles 17a because the semiconductor electrode 17 is formed of the metal oxide particles 17a of the nanometer size as shown in FIG. 2A.

According to operation principles of the dye-sensitized solar cell 100, light passing through the first transparent film 11 to reach the semiconductor electrode 17 through the holes 15 defined in the first metallic substrate 13. The dye particles 17b of the semiconductor electrode 17 generate electron-hole pairs while being excited by light. The electrons are injected into a conduction band of the metal oxide particles 17a. Then, the electrons are transferred into the first metallic substrate 13 through interfaces of metal oxide particles 17a to generate current. The electrons transferred into the first metallic substrate 13 move into the second metallic substrate 23. Then, the electrons are coupled to holes generated by the dye particles 17b through the electrolyte 32 and thus are reduced.

The light-transmittable dye-sensitized solar cell may be realized by defining the holes 15 in the first metallic substrate 13 without using an expensive transparent electrode layer or transparent polymer film such as ITO. Accordingly, the manufacturing costs of the solar cell can be reduced. Also, when the first metallic substrate 13 and the second metallic substrate 23 are formed of the metal foil, a light solar cell may be realized. Furthermore, since light passing through the holes 15 defined in the first metallic substrate 13 passes through the holes 15 defined in the second metallic substrate 23, a translucent solar cell may be provided.

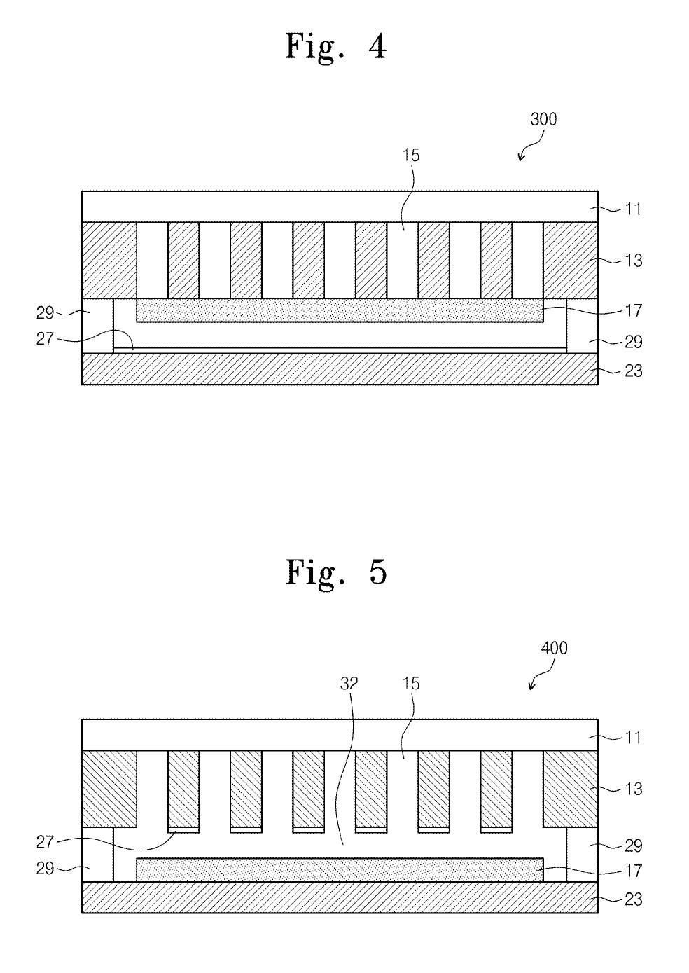

FIG. 4 is a cross-sectional view of a dye-sensitized solar cell according to another embodiment of the present invention. FIG. 5 is a cross-sectional view illustrating a modified example of the dye-sensitized solar cell of FIG. 4 according to another embodiment of the present invention.

Substantially the same elements as those of the foregoing embodiment in another embodiment described with reference to FIGS. 4 to 5 will be denoted by the same reference numerals, and thus detailed descriptions thereof will be omitted.

Referring to FIG. 4, according to a dye-sensitized solar cell 300, a first metallic substrate 13 may be disposed on one surface of a first transparent film 11. The first metallic substrate 13 may be disposed to face a second metallic substrate 23.

Each of the first metallic substrate 13 and the second metallic substrate 23 may be formed of an opaque metal material. Each of the first metallic substrate 13 and the second metallic substrate 23 may be formed of titanium (Ti), nickel (Ni), silver (Ag), copper (Cu), tungsten (W), iron (Fe), and an alloy including at least one of these materials. Furthermore, the first metallic substrate 13 and the second metallic substrate 23 may be a stainless steel substrate. The first metallic substrate 13 and the second metallic substrate 23 may be a metal foil. The first metallic substrate 13 may include a plurality of holes 15. A portion of a top surface of the first transparent film 11 may be exposed by the holes 15. Unlike this, the second metallic substrate 23 may not include the holes 15. Accordingly, the second metallic substrate 23 may be a flat substrate. Accordingly, the dye-sensitized solar cell 300 may be an opaque solar cell different from the dye-sensitized solar cells 100 and 200.

A sealing pillar 29 may be disposed between edges of the first metallic substrate 13 and the second metallic substrate 23. The sealing pillar 29 may attach the first metallic substrate 13 to the second metallic substrate 23 to provide a space between the first metallic substrate 13 and the second metallic substrate 23.

A semiconductor electrode 17 may be disposed on the first metallic substrate 13. A counter electrode 27 may be disposed on the second metallic substrate 23 so that the semiconductor electrode 17 and the counter electrode 27 are spaced facing each other.

Referring to FIG. 5 which illustrates a modified example of the dye-sensitized solar cell 300 of FIG. 4, a counter electrode 27 may be disposed on a first metallic substrate 13. A semiconductor electrode 17 may be disposed on a second metallic substrate 23. The counter electrode 27 may be disposed on the first metallic substrate 13 to expose holes 15. Accordingly, light incident into a first transparent film 11 may pass through the holes 15 to reach the semiconductor electrode 17. The second metallic substrate 23 may not include the holes 15. Accordingly, a dye-sensitized solar cell 400 may be an opaque solar cell.

Referring again to FIG. 4, an electrolyte 32 may be filled in a space between the first metallic substrate 13 and the second metallic substrate 23. The electrolyte 32 may be filled in the holes 15.

In the dye-sensitized solar cell according to the embodiments of the present invention, the substrate may be used as the flexible opaque metal plate, and the plurality of holes may be defined in the metal substrate to allow external light to reach the dye particles through the holes.

Accordingly, the dye-sensitized solar cell may be realized by using the inexpensive metallic substrate without using the expensive transparent electrode such as the ITO or FTO substrates. Therefore, the manufacturing costs of the dye-sensitized solar cell can be reduced.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation.

What is claimed is:

1. A dye-sensitized solar cell comprising:
a first metallic substrate disposed on a first transparent film;
a first electrode disposed on one surface of the first metallic substrate;
a second metallic substrate facing the first metallic substrate;
a second electrode disposed on one surface of the second metallic substrate to face the first electrode; and
an electrolyte disposed between the first electrode and the second electrode,
wherein the first metallic substrate comprises a plurality of holes exposing a portion of the first transparent film.

2. The dye-sensitized solar cell of claim 1, wherein the first electrode comprises metal oxide particles and dye particles surrounded by the metal oxide particles.

3. The dye-sensitized solar cell of claim 2, further comprising a second transparent film disposed on the other surface of the second metallic substrate, wherein the second metallic substrate comprises a plurality of holes exposing a portion of the second transparent film.

4. The dye-sensitized solar cell of claim 3, wherein the second electrode exposes the holes of the second metallic substrate.

5. The dye-sensitized solar cell of claim 1, wherein the second electrode comprises metal oxide particles and dye particles surrounded by the metal oxide particles.

6. The dye-sensitized solar cell of claim 5, further comprising a second transparent film disposed on the other surface of the second metallic substrate.
wherein the second metallic substrate comprises a plurality of holes exposing a portion of the second transparent film.

7. The dye-sensitized solar cell of claim 6, wherein the first electrode exposes the holes of the first metallic substrate.

8. The dye-sensitized solar cell of claim 1, wherein the first transparent film is a film formed of a glass or polymer material.

9. The dye-sensitized solar cell of claim 1, wherein the second metallic substrate is a flat substrate.

10. The dye-sensitized solar cell of claim 1, wherein the plurality of the holes are defined in central portions of the first metallic substrate.

11. The dye-sensitized solar cell of claim 1, wherein each of the first metallic substrate and the second metallic substrate is formed of a metal foil.

12. The dye-sensitized solar cell of claim 1, wherein each of the first metallic substrate and the second metallic substrate is formed of titanium (Ti), nickel (Ni), silver (Ag), copper (Cu), tungsten (W), iron (Fe), an alloy comprising at least one of these metals, or stainless steel.

13. The dye-sensitized solar cell of claim 1, wherein the electrolyte is filled into the plurality of holes of the first metallic substrate.

14. The dye-sensitized solar cell of claim 1, further comprising sealing pillars disposed between the first electrode and the second electrode.
